(19) United States
(12) Patent Application Publication
(10) Pub. No.: US 2008/0317098 A1
(43) Pub. Date: Dec. 25, 2008

(54) Low Power Radio Device With Reduced Interference

(76) Inventor: Juha O. Juntunen, Espoo (FI)

Correspondence Address: MORGAN & FINNEGAN, L.L.P., 3 WORLD FINANCIAL CENTER, NEW YORK, NY, 10281-2101, US

(21) Appl. No.: 12/086,844

(22) PCT Filed: Dec. 22, 2005
(86) PCT No.: PCT/IB2005/004025

§ 371 Date: Jun. 20, 2008

(51) Int. Cl. H04B 1/62

(52) U.S. Cl. 375/130; 375/E01.001

(57) ABSTRACT

A low power radio device, operable in a first radio system, comprising: a detector for detecting the polarization of an antenna of a further radio device, operating in a further radio system, different to the first radio system; and a transmitter for controlling the polarization of a transmitted radio signal in dependence on the detected polarization. The polarization of the transmitted signal may be controlled to be substantially orthogonal to the polarization of the antenna of the further radio device.

### FIELD OF THE INVENTION

Embodiments of the present invention relate to a low power radio device. In particular, they relate to a low power radio device for use in a radio system that operates using Ultra Wide Bandwidth (UWB) signals or any other wideband radio frequency system.

### BACKGROUND TO THE INVENTION

UWB is a wireless radio technology. A UWB transmitter works by sending a signal across a very wide spectrum of frequencies. A corresponding receiver translates the signal into data. UWB technology may be defined as any radio technology having a spectrum that occupies a bandwidth greater than 20% of the centre frequency, or a bandwidth of at least 500 MHz.

UWB is typically suited for transmitting data between consumer electronics, personal computers and mobile devices. UWB has the capacity to handle very high bandwidths of data, at very high speeds across short ranges. For example, UWB devices may be used to transport multiple audio or video streams.

An example of a standard that incorporates UWB is the Wireless Universal Serial Bus (WUSB) Specification, Revision 1.0. WUSB aims to provide a data rate of 480 Mbps over a distance of 3 metres and 110 Mbps over a distance of 10 metres.

In the United States, the Federal Communications Commission (FCC) has mandated that UWB radio transmissions can legally operate in the frequency range 3.1 GHZ to 10.6 GHz, at a limited transmit power of −41.3 dBm/MHz. UWB radio transmissions can also legally operate in the frequency range 1 GHz to 3.1 Ghz, but at a lower power than those in the 3.1 GHZ to 10.6 GHz range.

The GSM cellular system operates at approximate frequencies of 850, 900, 1800 and 1900 MHz. As UWB devices may emit radiowaves in the frequency range 1 GHz to 3.1 GHz, they may cause interference to mobile terminals using some GSM frequencies, and/or some WCDMA frequencies and/or 802.11g frequencies or Bluetooth frequencies. The large bandwidth used in UWB devices means that UWB transmissions having a centre frequency 500 MHz or more away from the GSM frequencies may still cause interference.

Furthermore, it is currently envisaged that the fourth generation of radio telephone systems (4G) will operate somewhere in the frequency range 3 GHz to 5 GHz. As UWB devices are allowed to operate in the frequency range of 3.1 GHZ to 10.6 GHz, it is envisaged that UWB devices may cause interference at 4G mobile terminals.

### BRIEF DESCRIPTION OF THE INVENTION

According to first aspect of the present invention, there is provided a low power radio device, operable in a first radio system, comprising: a detector for detecting the polarization of an antenna of a further radio device, operating in a further radio system, different to the first radio system; and a transmitter for controlling the polarization of a transmitted radio signal in dependence on the detected polarization.

According to a second aspect of the present invention, there is provided a method for controlling the polarization of a transmitted signal for a first low power radio system, comprising the steps of: detecting the polarization of an antenna of a radio device, operating in a further radio system, different to the first low power radio system; and controlling the polarization of a transmitted radio signal for the first low power radio system in dependence on the detected polarization.

According to a third aspect of the present invention, there is provided a computer program for use in a low power radio device having an antenna for receiving radio signals comprising two non-parallel elements, the computer program comprising: means for receiving a first signal from a first antenna element and for receiving a second signal from a second antenna element; means for processing the received first and second signals to determine the polarization of a radio signal incident upon the antenna; means for changing the effective polarization of the antenna to change the polarization of low power radio signals transmitted by the antenna in dependence on the polarization of the incident radio signal.

In embodiments of the present invention, a low power radio device is advantageously able to reduce the amount of interference it causes at a further radio device when it transmits a radio signal, by: a) detecting the polarization of an antenna of a further radio device, and b) controlling the polarization of a radio signal it transmits in dependence on the detected polarization.

Typically, a low power radio device is a device that is operable to transmit signals with a maximum range of 100 metres or less, and/or receive radio signals that have been transmitted with a maximum range of 100 metres or less. In particular, some low power radio devices are operable to transmit signals with a maximum range of 10 metres or less, and/or receive radio signals that have been transmitted with a maximum range of 10 metres or less. UWB devices are often operable to transmit signals with a maximum range of 3 metres or less, and/or receive radio signals that have been transmitted with a maximum range of 3 metres or less.

According to a fourth aspect of the present invention, there is provided an arrangement comprising a first low power radio device and a second low power radio device, operable in a first radio system, wherein: the first low power radio device comprises: a detector for detecting the polarization of an antenna of a further radio device, operating in a further radio system, different to the first radio system; and a transmitter for controlling the polarization of a transmitted radio signal in dependence on the detected polarization; and the second low power radio device comprises: a receiver for receiving a radio signal; and a transmitter for controlling the polarization of a transmitted radio signal in dependence on the polarization of the received radio signal.

According to a fifth aspect of the present invention there is provided a method for controlling the polarization of radio signals for a first radio system including a first low power radio device and a second low power radio device, comprising the steps of: a first low power radio device detecting a polarization of an antenna of a further radio device, operating in a further radio system, different to the first radio system; the first low power radio device controlling a polarization of a transmitted radio signal in dependence on the detected polarization; a second low power radio device receiving a radio signal; and the second low power radio device controlling a polarization of a transmitted radio signal in dependence on the polarization of the received radio signal.

Advantageously, in embodiments of the present invention, the amount of interference caused at a further radio device by an arrangement of low power radio devices may be reduced.

Interference from a first low power radio device in the arrangement may be reduced by the first low power radio device: a) detecting the polarization of an antenna of the further radio device and b) controlling the polarization of a transmitted radio signal in dependence on the detected polarization. Interference from a second low power radio device in the arrangement may be reduced by the second low power radio device: a) receiving a radio signal and b) controlling the polarization of a transmitted radio signal in dependence on the polarization of the received radio signal.

Advantageously, the controlling of the polarization of a transmitted radio signal by the first and second low power radio devices may lead to the radio signals transmitted by the first and second low power radio devices having substantially the same polarization, so the amplitude of the radio signals received at the second and first low power radio devices is maximised.

According to a sixth aspect of the present invention, there is provided a chipset for use in a low power radio device having an antenna for receiving radio signals comprising two non-parallel elements, the chipset comprising: means for receiving a first signal from a first antenna element and for receiving a second signal from a second antenna element; means for processing the received first and second signals to determine the polarization of a radio signal incident upon the antenna; means for changing the effective polarization of the antenna to change the polarization of low power radio signals transmitted by the antenna in dependence on the polarization of the incident radio signal.

### BRIEF DESCRIPTION OF THE DRAWINGS

For a better understanding of the present invention, reference will now be made by way of example only to the accompanying drawings in which:

FIG. 1 illustrates a UWB device;

FIG. 2 illustrates a UWB radio system/arrangement comprising two UWB devices, and a nearby cellular mobile terminal communicating with a cellular base station; and

FIG. 3 illustrates a dual polarized wedge dipole suitable for use in a UWB device.

### DETAILED DESCRIPTION OF EMBODIMENTS OF THE INVENTION

The Figures illustrate a low power radio device 10, operable in a first radio system 100, comprising: a detector 12, 14 for detecting the polarization of an antenna 221 of a further radio device 220, operating in a further radio system 200, different to the first radio system 100; and a transmitter 12 for controlling the polarization of a transmitted radio signal 13 in dependence on the detected polarization.

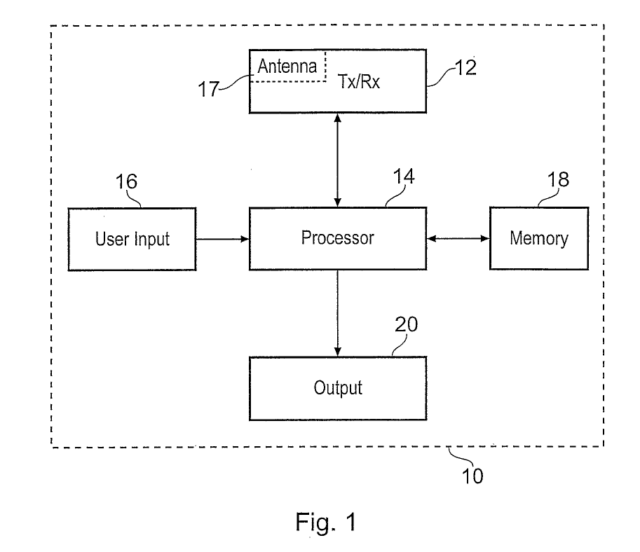

FIG. 1 is a schematic illustration of a UWB device 10. The UWB device 10 may be hand portable. The UWB device comprises a radio frequency transceiver 12, a processor 14, a user input 16, a memory 18 and an output 20.

The transceiver 12 comprises a transmitter, a receiver and an antenna 17 and is operable to transmit and receive UWB radio frequency signals. The processor 14 is connected to receive an input from the transceiver 12 and the user input 16 and to read from the memory 18, and to provide an output to the transceiver 12 and the output 20, and to write to the memory 18. The user input 16 may, for instance, comprise a keypad or other device for user input. The output is for conveying information to a user and may, for instance, comprise a display. The input 16 and the output 20 may be combined, for instance, in a touch sensitive display device.

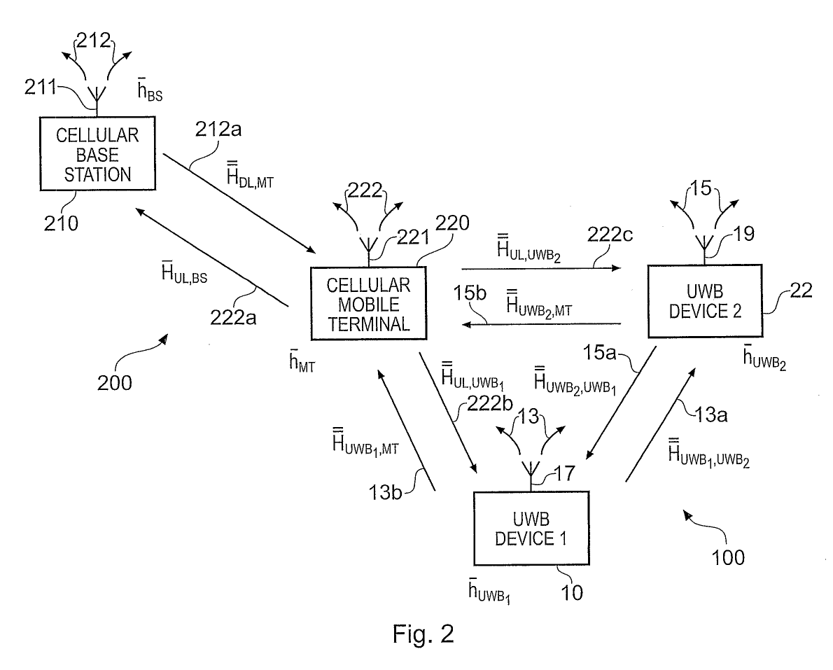

FIG. 2 illustrates a UWB radio arrangement/system 100 comprising a first UWB device 10 in communication with a second UWB device 22. The second UWB device 22 in this example takes the same form as the first UWB device 10 illustrated in FIG. 1. The antenna of the second UWB device 22 has been denoted using the reference numeral 19 in FIG. 2 for clarity, but it may take the same form as the antenna 17 of the first UWB device 10. FIG. 2 also illustrates a portion of a cellular radio system 200 comprising a cellular base station 210 in communication with a cellular mobile terminal 220.

In FIG. 2, the complex vector h̅_{A} represents the antenna polarization and directional gain properties of a given device A. The skilled reader will be aware that h̅_{A} is a function of the three dimensional incident or departure angles (ū_{R}, ū_{T})(radial vectors) of the radio waves that are transmitted or received by device A (i.e. h̅_{A} (ū_{R}) and h̅_{A} (ū_{T})). H̅_{B,C} represents the radio wave propagation effect of a signal B that is received by a device C and transmitted by device A. H̅_{B,C} is a dyadic tensor or matrix, which transforms a transmitted polarization vector to another vector representing the plane wave electric field component that is received at the receiving antenna.

The first UWB device 10, in this example, is positioned close to the second UWB device 22 and also the cellular mobile terminal 220. A distance of less than ten metres separates the first UWB device 10 and the second UWB device 22, and the first UWB device 10 and the cellular mobile terminal 220. The cellular mobile terminal 220 is typically positioned within a distance of a few kilometres from the cellular base station 210.

The cellular base station 210 communicates with the cellular mobile terminal 220 by transmitting a downlink signal 212. The downlink signal 212 may be transmitted by the base station 210 in a number of different directions. The reference numeral 212a denotes the portion of the transmitted downlink signal 212 that travels from the base station 210 to the mobile terminal 220.

The mobile terminal 220 communicates with the base station 210 by transmitting an uplink signal 222. The uplink signal 222 transmitted by the mobile station 220 may also be transmitted in a number of different directions. The reference numeral 222a denotes the portion of the transmitted uplink signal 222 that travels from the cellular mobile terminal 220 to the base station 210.

The first UWB device 10 may communicate with the second UWB device 22 by transmitting a first UWB signal 13. The UWB signal 13 may be transmitted by the first UWB device 10 in a number of different directions. The reference numeral 13a denotes the portion of the first UWB signal 13 that travels from the first UWB device 10 to the second UWB device 22. The second UWB device 22 may communicate with the first UWB device 10 by transmitting a second UWB signal 15. Similarly, the reference numeral 15a denotes the portion of the second UWB signal 15 that travels from the second UWB device 22 to the first UWB device 10.

Each of the signals 13, 15, 212 and 222 comprise electromagnetic radio waves having a particular polarization. The polarization of an electromagnetic wave is determined by the change in the orientation of its electric field vector over time.

An electromagnetic wave is said to be linearly polarized if the direction of its electric field vector oscillates in a single plane. An electromagnetic wave is vertically polarized if it has a linear polarization that is perpendicular to the Earth's surface. An electromagnetic wave is horizontally polarized if it has a linear polarization that is parallel to the Earth's surface.

Where an antenna is linearly polarized, the polarization of a transmitted radio wave will be the same as the polarization of the transmitting antenna. For example, if the transmitting antenna is vertically polarized, the transmitted radio wave will also be vertically polarized.

Other types of polarization include circular polarization and elliptical polarization. If an electromagnetic wave is composed of two plane waves of equal amplitude differing in phase by 90°, then the electromagnetic wave is said to be circularly polarized. This is because the superposition of the two plane waves produces a resultant electromagnetic wave with an electric field vector that traces out a circle over time.

If two plane electromagnetic waves of differing amplitude are related in phase by 90°, or if the relative phase is other than 90°, the electromagnetic wave is said to be elliptically polarized. This is because the superposition of the two plane waves produces a resultant electromagnetic wave with an electric field vector that traces out an ellipse over time.

The transmitting antenna 211 at the base station 210 may, for instance, be a linearly polarized vertical antenna, or an antenna with a polarization of 45° to the vertical. Other polarizations are, however, possible. The base station 210 may also have a dual-polarized antenna setup, comprising two orthogonal antenna elements such as a vertical antenna element and a horizontal antenna element.

If there is a line of sight between the base station 210 and the cellular mobile terminal 220, the polarization of the downlink signal portion 212a received at the mobile terminal 220 will be the same when it is received at the mobile terminal 220 as the polarization of the downlink signal 212 originally transmitted by the base station 210.

If the downlink signal portion 212a has been reflected before it reaches the mobile terminal 220, the polarization of the downlink signal 212a when it is received by the mobile terminal 220 may be different to the polarization of the downlink signal 212 originally transmitted by the base station 210.

Reflection of a signal can also cause a signal to follow multiple different paths before it reaches a receiver. To enable the skilled reader to understand embodiments of the invention more easily, the analysis below considers one signal component of the downlink signal portion 212a, without considering multipath signals caused by reflection, for example. The narrow-band base station downlink signal portion 212a received by the mobile terminal 220 in the one signal path case is given by:

V_{DL}= h̅_{MT}· H̅_{DL,MT}· h̅_{BS} (1)

where the subscript DL represents the downlink signal portion 212a that travels from the base station 210 to the mobile terminal 220, the subscript MT represents the mobile terminal 220 and the subscript BS represents the base station 210.

If we were to consider multipath propagation, the downlink signal portion 212a would be given by:

V_{DL}=∫∫ h̅_{MT}(ū_{R})· H̅_{DL,MT}(ū_{T}, ū_{R})· h̅_{BS}(ū_{T})dū_{T}dū_{R} (2)

where ū_{T} is the angle of transmission of the downlink signal portion 212a by the base station 210 and ū_{R} is the angle of reception of the downlink signal portion 212a by the mobile terminal 220.

The antenna 221 of the cellular mobile terminal 220 also has a polarization. The amplitude of the signal received by the mobile terminal 220 is maximised if the polarization of the antenna 221 of the mobile terminal 220 matches that of the downlink signal portion 212a that is incident upon it. The amplitude of the received signal depends upon the orientation of the receiving antenna in comparison to the incident wave.

The first UWB device 10 may communicate with the second UWB device 22 by transmitting a UWB signal 13. The portion of the signal 13 that travels from the first UWB device 10 to the second UWB device 22 is denoted with the reference numeral 13a. If the receiver of the mobile terminal 220 is operable to receive signals of the same frequency as the frequency of the UWB signal 13, when the UWB signal 13 is transmitted, a portion 13b of the transmitted UWB signal 13 may inadvertently be received by the mobile terminal 220. The UWB signal portion 13b may therefore cause interference at the mobile terminal 220 when it is receiving the downlink signal portion 212a from the base station 210.

The UWB signal portion 13b transmitted by the first UWB device 10 and received at the mobile cellular terminal 220 is given by:

V_{UWB}_{₁}_{,MT}= h̅_{MT}· H̅_{UMB}_{₁}_{,MT}· h̅_{UMB}_{₁} (3)

where the subscript UWB₁ denotes the first UWB device 10 or the UWB signal portion 13b transmitted by the first UWB device 10 and received at the mobile terminal 220.

While UWB signals are generally transmitted at a very low power so as to minimise any potential interference, a significant interference effect at the mobile terminal 220 can occur, particularly if: a) the downlink signal portion 212a has been reduced significantly in power when it is received at the cellular mobile terminal 220, for example because the mobile terminal 220 is positioned a long distance from the base station 210 or because reflection and refraction of the signal portion 212a along its path have reduced its power, and/or if: b) the first UWB device 10 is positioned very close to the mobile terminal 220 (i.e. within a distance of a few metres).

If the antenna properties and alignment of the mobile terminal 220 (characterised by h̅_{MT}) and the change in polarization of the UWB signal portion 13b between the transmission of the signal 13 by the first UWB device 10 and the reception of the UWB signal portion 13b by the mobile terminal 220 (characterised by H̅_{UWB}_{₁}_{,MT}) were known by the first UWB device 10, it could transmit a radio signal with a polarization corresponding to:

h̅_{UMB}_{₁}= H̅_{UMB}_{₁}_{MT}⁻¹·(ū_{R}× h̅_{MT}) (4)

In this case, the UWB signal portion 13b is not received by the cellular terminal 220 because, from equation (3), it follows that:

V_{UWB}_{₁}_{,MT}= h̅_{MT}· H̅_{UMB}_{₁}_{,MT}·( H̅_{UMB}_{₁}_{MT}⁻¹·(ū_{R}× h̅_{MT}))= h̅_{MT}(ū_{R}× h̅_{MT})=0 (5)

h̅_{MT} and H̅_{UMB}_{₁}_{,MT}, however, are not generally known by the UWB device 10, so it cannot simply produce a radio signal according to equation (5).

The mobile station 220 also communicates with the base station 210 by transmitting an uplink signal 222. The uplink signal 222 has the same polarization as the transmitting antenna 221 of the mobile terminal 220. If the same antenna 221 is used for receiving signals as for transmitting signals by the mobile terminal 220, the polarization of the uplink signal 222 is the same as the polarization of the antenna used to receive signals by the mobile terminal 220.

A portion 222b of the uplink signal 222 travels from the mobile terminal 220 to the first UWB device 10. As there is a line of sight between the first UWB device 10 and the mobile terminal 220, the polarization of the uplink signal portion 222b received at the first UWB device 10 is then substantially the same as the originally transmitted uplink signal 222. The polarization of the UWB signal portion 13b received at the mobile terminal 220 also has the substantially the same polarization as the originally transmitted UWB signal 13.

The electric field Ē_{UL,UWB}_{₁} corresponding to the uplink signal 222b that is to be received by the antenna 17 of first UWB device 10 can be represented in terms of the radio wave propagation effect H̅_{UL,UWB}_{₁} and the antenna vector h̅_{MT}, as:

Ē_{UL,UWB}_{₁}= H̅_{UL,UWB}_{₁}· h̅_{MT} (6)

If the electric field Ē_{UL,UWB}_{₁} is detected by the first UWB device 10, it can transmit a UWB radio signal 13 having a polarization corresponding to:

h̅_{UWB}_{₁}=ū_{T}×Ē_{UL,UWB}_{₁}=ū_{T}×( H̅_{UL,UWB}_{₁}· h̅_{MT}) (7)

A UWB signal 13 according to equation (7) has a polarization that is orthogonal to, or mismatched with, the polarization of the detected uplink signal portion 222b. From equation (3), it follows that the UWB signal portion 13b received by the mobile terminal 220 is:

V_{UWB}_{₁}_{,MT}= h̅_{MT}· H̅_{UWB}_{₁}_{,MT}[ū_{T}×( H̅_{UL,UWB}_{₁}· h̅MT)] (8)

If we approximate the propagation medium to be isotropic, and there is a line of sight between the first UWB device 10 and the cellular mobile terminal 220:

H̅_{UL,UWB}_{₁}= H̅UWB_{₁}_{,MT \tilde{=}} I̅ (9)

where I̅ is an identity matrix. It then follows that:

V_{UWB}_{₁}_{,MT}=0 (10)

and hence the interference caused by the UWB signal portion 13b at the mobile terminal 220 is zero.

The interference at the mobile terminal 220 caused by the UWB signal portion 13b can therefore be minimised if the polarization of the transmitted UWB signal 13 is carefully controlled to be orthogonal to the downlink signal portion 222a that is received at the mobile terminal 220.

Where the mobile terminal 220 has a linearly polarized antenna and the UWB signal 13 is also linearly polarized, if the UWB signal portion 13b has a polarization at the antenna 221 of the mobile terminal 220 which is orthogonal to the polarization of the antenna 221 of the mobile terminal 220, the UWB signal portion 13b will not theoretically be received by the mobile terminal 220.

Where the mobile terminal 220 has a circularly polarized antenna and the UWB signal 13 is also circularly polarized, if the UWB signal portion 13b has a polarization at the antenna 221 of the mobile terminal 220 which is maintained orthogonal to the polarization of the antenna 221 of the mobile terminal 220, the UWB signal portion 13b may not be detected by the mobile terminal 220.

The closer the polarization of the UWB signal portion 13b is to being orthogonal to the receiving antenna of the mobile terminal 220 when it reaches the mobile terminal 220, the smaller the amplitude of the received UWB signal portion 13b will be at the mobile terminal 220, and smaller level of the interference caused by the UWB signal portion 13b at the mobile terminal 220 will be.

The detection of the polarization of the antenna 221 of the mobile terminal 220 and the controlling of the effective polarization of antenna 17 of the UWB device 10 may be initiated by a user. The user may use the user input 16 to request the detection of nearby radio devices that the UWB device 10 has the potential to interfere with. The user may then instruct the device 10 to control its effective polarization to minimise interference. Alternatively, the UWB device 10 may automatically detect the polarization of the antenna 221 of the mobile terminal 220 and control the effective polarization of its antenna 17 without user intervention.

The process of detecting the polarization of the antenna 221 of the mobile terminal 220 and controlling the effective polarization of the antenna 17 of the UWB device 10 may occur before a UWB signal 13 is transmitted by the UWB device 10.

The UWB device 10 may attempt to detect signals from other radio devices periodically, to circumvent any possible interference problems at those radio devices. It may be the case that the mobile terminal 220 is not in the vicinity of the UWB device 10 when the UWB device 10 begins transmitting UWB signals, but is later brought close to the UWB device 10. In this situation, the UWB device 10 detects the polarization of the antenna 221 of the mobile terminal 220 and adapts the effective polarization of its antenna 17 to minimise or reduce interference with the mobile terminal 220.

While in practice it may be difficult to ensure that the UWB signal 13 has a polarization that is precisely orthogonal to the polarization of the antenna 221 of the mobile terminal 220, in reality a 10 to 15 dB interference reduction can be achieved.

A portion 13a of the first UWB signal 13 is received by the second UWB device 22. In order to maximise the amplitude of the signal portion 13a that is received at the second UWB device 22, the second UWB device 22 matches the effective polarization of its antenna 19 to the effective polarization of the antenna 17 of first UWB device 10 and the polarization of the first UWB signal 13.

The second UWB device 22 transmits a second UWB signal 15. A portion of 15a of the second UWB signal 15 is received by the first UWB device 10. The matching of the effective polarization of the antenna of the second UWB device 22 has the effect of reducing the interference caused at the mobile terminal 220 by a portion 15b of the second UWB signal 15 that may be received at the mobile terminal 220 as the effective polarization of the antenna 19 of the second UWB device 22, when matched with the effective polarization of the antenna 17 of the first UWB device 10, is orthogonal to the polarization of the antenna 221 of the mobile terminal 220.

In the case where the each UWB device 10, 22 has two or more separate antennas for transmitting and receiving, the effective polarization of the transmitting and receiving antennas of both of the UWB devices 10, 22 are matched, so that the effective polarization of all of the antennas are the same.

The second UWB device 10 may achieve the polarization match in a number of ways. The second UWB device 22 may go through the same process of detecting the mobile terminal 220 through a portion of the uplink signal 222 and mismatching the effective polarization of its antenna 19 with the detected uplink signal portion as the first UWB device 10. In this case, if there is a line of sight between the first UWB device 10 and mobile terminal 210 and the second UWB device 22 and mobile terminal 220, the effective polarization of the antennas 17, 19 of the first and second UWB devices 10, 22 are the same.

Alternatively, the second UWB device 22 may detect the polarization of the portion 13a of the UWB signal 13 and match the effective polarization of its antenna 19 with that of the UWB signal portion 13a. In this case, the effective polarization of the antenna 19 of the second UWB device 22 will be the same as that of the antenna 17 of the first UWB device 10, provided that there is a line of sight between the first and second UWB devices 10, 22. Furthermore, provided that a line of sight also exists between the second UWB device 22 and the mobile terminal 220, the effective polarization of the antenna 19 of the UWB device 22 and therefore the polarization of the second transmitted UWB signal 22 will be orthogonal to, or mismatched with, the antenna 221 of the mobile cellular terminal 220.

A line of sight between the first UWB device 10 and the second UWB device 22 can be assumed in most cases, because the power of the transmitted UWB signals 13, 15, is so low. If there is no line of sight between the UWB devices 10, 22 no signal will be received by the receiving device, in most instances, or the signal will be received only at a very low level.

Alternatively, the first UWB device 10 can communicate the effective polarization of its antenna to the second UWB device 22 in the first UWB signal 13. In order to communicate its effective polarization, the first UWB device 10 may need to know its orientation. This could be achieved by using gravity and/or acceleration sensors to find out the orientation of the UWB device 10 with respect to the gravity. If the second UWB device 22 also has gravity or acceleration sensors to find its orientation, it can align the effective polarization of its antenna 19 with that of the first UWB device 10.

In a situation where there is more than one device at which the transmission of UWB signals 13, 15 could cause interference (i.e. there is more than one device in the vicinity of the UWB devices 10, 22), the UWB devices 10, 22 may communicate with each other to determine which of the other devices is most relevant when considering how the polarization of transmitted UWB signals 13, 15 should be orientated. The decision as to how the polarization should be orientated may be based upon the amplitude of the signals made by the other devices at the UWB devices 10,22.

For instance, if there are two mobile terminals in the vicinity of the UWB devices 10, 22, but the detected uplink signal portion 222b, 222c at the UWB devices 10, 22 is higher for a first one of the mobile terminals than for a second, the UWB devices may choose to mismatch the polarization of the UWB signals 13, 15 they transmit with the antenna of the first mobile terminal, and not the second.

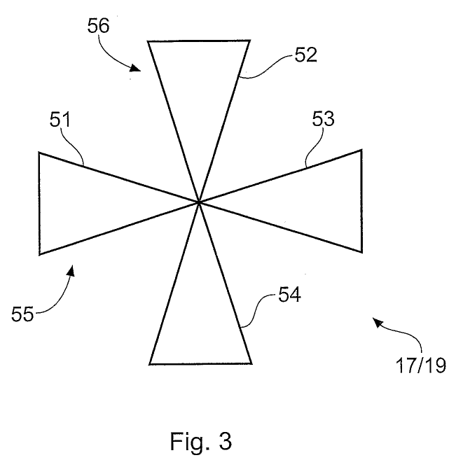

FIG. 3 illustrates a dual-polarized wedge dipole antenna 17/19 for use in the UWB devices 10, 22. The dual-polarized wedge dipole antenna 17/19 comprises four wedge-shaped portions, 51, 52, 53 and 54, and is part of the transceiver 12. The portions 51 to 54 take the form of isosceles triangles.

Wedge portions 51 and 53 form a first antenna element 55. Wedge portions 52 and 54 form a second antenna element 56, which has a polarization that is orthogonal to that of the first antenna element 55. The polarization of an electromagnetic wave incident upon the wedge dipole antenna 17/19 may be found by measuring how the amplitude and phase of the signals received on each antenna element 55, 56 relate to each other.

Computer program instructions for controlling the effective polarization of the wedge dipole antenna 17/19 are stored in the memory 18. When the computer program instructions are loaded into the processor 14, the UWB device 10, 22 changes the effective polarization of the wedge dipole antenna 17/19 when transmitting signals by applying a different level of gain and/or by applying a different delay to the signal applied to each different antenna element 55, 56. If the UWB device 10, 22 is configured to transmit a linearly polarized wave, solely changing the gain will cause the antenna 17/19 to transmit a linearly polarised wave with a different polarization angle. Changing the delay will result in a phase shift between the signal components applied to each different wedge 51 to 54, and the transmitted wave will be circularly or elliptically polarized. The UWB device 10, 22 changes the effective polarization of the wedge dipole antenna 17/19 when receiving signals by applying a different level of gain and/or by applying a delay to the signal received from each different wedge 51 to 54.

The computer program instructions may arrive at the UWB devices 10, 22 via an electromagnetic carrier signal or be copied from a physical entity such as a computer program product, a memory device or a record medium such as a CD-ROM or DVD.

Although embodiments of the present invention have been described in the preceding paragraphs with reference to various examples, it should be appreciated that modifications to the examples given can be made without departing from the scope of the invention as claimed. For example, embodiments of the invention have been described above in relation to UWB devices, but could be applied to any other type of low power radio device that is capable of causing interference. The device that may potentially suffer from interference in the above description was a cellular mobile terminal 220, which was part of a cellular system 200. The skilled person will appreciate that embodiments of the invention could be used to alleviate potential interference problems at other types of radio device operating in other radio systems, such as those operating in an 802.11 WLAN network, or a Bluetooth system.

Furthermore, the UWB devices 10,22 described in the description comprise a processor 14. As an alternative to the processor 14, or in addition to the processor 14, the UWB devices 10,22 may comprise a chipset. The chipset may comprise one or more integrated circuits.

While the above description describes a preferred implementation, it should be appreciated that benefits of the invention may be obtained by varying the described implementation. Although in the preceding example, a linear polarization for a signal 13 produced by the first UWB device 10 is controlled to be orthogonal to the polarization of the antenna of the cellular mobile terminal 220, it should be appreciated that this is an optimal solution. Benefits may be obtained by controlling the polarization of the signal 13 so that it has a reduced component parallel to the polarization of the antenna 221, but is not necessarily orthogonal to it.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A radio device, configured to operate in a first radio system, comprising:
a detector configured to detect the polarization of an antenna of a further radio device operating in a further radio system different from the first radio system; and
a transmitter configured to control the polarization of a transmitted radio signal in dependence on the detected polarization.

2. A radio device as claimed in claim 1, wherein the polarization of the transmitted signal is controlled to be substantially orthogonal to the polarization of the antenna of the further radio device.

3. A radio device as claimed in claim 1, wherein the transmitter has a first effective polarization for transmitting a first radio signal having a first polarization, and is configured to change its effective polarization in dependence on the detected polarization, from the first effective polarization to a second effective polarization for transmitting a second radio signal having a second polarization, wherein the second polarization is different from the first polarization.

4. A radio device as claimed in claim 3, wherein the second polarization is substantially orthogonal to the polarization of the detected polarization.

5. A radio device as claimed in claim 1, wherein the detector is configured to detect the polarization of the antenna of the further radio device by detecting the polarization of a radio signal transmitted by the further radio device.

6. A radio device as claimed in claim 5, wherein the radio signal transmitted by the further radio device has a substantially linear polarization.

7. A radio device as claimed in claim 5, wherein the radio signal transmitted by the further radio device has a circular polarization.

8. A radio device as claimed in claim 5, wherein the radio signal transmitted by the further radio device has an elliptical polarization.

9. A radio device as claimed in claim 5, further comprising an antenna configured to receive the radio signal transmitted by the further radio device using two non-parallel antenna elements, wherein the radio signal received by each antenna element has an amplitude and a phase, and wherein the radio device is configured to determine the polarization of the received radio signal based on the values of the amplitude and phase of the radio signals received at the respective antenna elements.

10. A radio device as claimed in claim 5, wherein the detector is configured to detect a radio signal transmitted by the further radio device having a frequency situated within a frequency range that the radio device is configured to transmit in.

11. A radio device as claimed in claim 1, wherein the radio signal transmitted by the radio device is for a first radio system and for reception by a second radio device operating in the first radio system.

12. A radio device as claimed in claim 1, wherein the first radio system operates using Ultra Wide Bandwidth (UWB) signals.

13. A radio device as claimed in claim 1, wherein the further radio system has different operating protocols from the first radio system.

14. A radio device as claimed in claim 1, wherein the further radio system is a radio telephone system.

15. A radio device as claimed in claim 5, wherein the further radio system is a cellular telephone system and the radio signal transmitted by the further radio device is for reception by a cellular base station.

16. A method comprising:
detecting the polarization of an antenna of a radio device operating in a further radio system different from a first radio system; and
controlling the polarization of a transmitted radio signal for the first radio system in dependence on the detected polarization.

17. An article of manufacture, comprising:
a computer-readable medium containing computer-readable code, which when executed by a computer causes the computer to,
receive a first signal from a first antenna element and a second signal from a second antenna element;
process the received first and second signals to determine the polarization of a radio signal incident upon the antenna; and
change the effective polarization of the antenna to change the polarization of radio signals transmitted by the antenna in dependence on the polarization of the incident radio signal.

18. A system comprising:
a first radio device and a second radio device, configured to operate in a first radio system, wherein,
the first radio device comprises,
a detector configured to detect the polarization of an antenna of a further radio device operating in a further radio system different from the first radio system; and
a transmitter configured to control the polarization of a transmitted radio signal in dependence on the detected polarization; and wherein,
the second radio device comprises,
a receiver configured to receive a radio signal; and
a transmitter configured to control the polarization of a transmitted radio signal in dependence on the polarization of the received radio signal.

19. A system as claimed in claim 18, wherein a radio signal received by the receiver of the second radio device is a radio signal transmitted by the first radio device.

20. A system as claimed in claim 19, wherein the polarization of a radio signal transmitted by the second radio device is controlled by the transmitter of the second radio device to substantially match the polarization of a radio signal received by the second radio device.

21. A system as claimed in claim 19, wherein the receiver of the second radio device comprises a detector for detecting the polarization of the received signal.

22. A system as claimed in claim 19, wherein a radio signal transmitted by the first radio device and received by the second radio device contains information regarding its polarization.

23. A system as claimed in claim 18, wherein a radio signal received by the receiver of the second radio device is a radio signal transmitted by the further radio device.

24. A system as claimed in claim 23, wherein the polarization of a radio signal transmitted by the second radio device is controlled by the transmitter of the second radio device to be substantially orthogonal to the polarization of the radio signal received by the second radio device.

25. A method, comprising the steps of:
detecting, at a first radio device of a first radio system, a polarization of an antenna of a further radio device operating in a further radio system different from the first radio system;
controlling, at the first radio device, a polarization of a transmitted radio signal in dependence on the detected polarization;
receiving a radio signal at a second radio device of the first radio system; and
controlling, at the second radio device, a polarization of a transmitted radio signal in dependence on the polarization of the received radio signal.

26. A chipset, comprising:
means for receiving a first signal from a first antenna element and a second signal from a second antenna element;
means for processing the received first and second signals to determine the polarization of a radio signal incident upon an antenna; and
means for changing the effective polarization of the antenna to change the polarization of radio signals transmitted by the antenna in dependence on the polarization of the incident radio signal.

27. A method as claimed in claim 16, wherein the polarization of the transmitted signal is controlled to be substantially orthogonal to the polarization of the antenna of the radio device operating in the further radio system.

28. A method as claimed in claim 16, wherein detecting the polarization of the antenna of the radio device operating in the further radio system includes detecting the polarization of a radio signal transmitted by the radio device.

29. A method as claimed in claim 28, wherein the radio signal transmitted by the radio device has a substantially linear polarization.

30. A method as claimed in claim 28, wherein the radio signal transmitted by the radio device has a circular polarization.

31. A method as claimed in claim 28, wherein the radio signal transmitted by the radio device has an elliptical polarization.

32. A method as claimed in claim 28, further comprising:
receiving the radio signal transmitted by the radio device, via an antenna with two non-parallel antenna elements, wherein the radio signal received by each antenna element has an amplitude and a phase; and
determining the polarization of the received radio signal based on the amplitude and the phase of the radio signals received at the respective antenna elements.

33. A method as claimed in claim 16, further comprising:
detecting a radio signal transmitted by the further radio device having a frequency situated within a frequency range that the first radio system is configured to transmit in.

34. A method as claimed in claim 16, wherein the first radio system is a short-range wireless communication network and the further radio system is a cellular communication network.

35. A radio device as claimed in claim 1, wherein the first radio system is a short-range wireless communication network and the further radio system is a cellular communication network.
